(19) United States
(12) Patent Application Publication
(10) Pub. No.: US 2005/0151949 A1
(43) Pub. Date: Jul. 14, 2005

(54) Process and apparatus for applying apodization to maskless optical direct write lithography processes

(75) Inventors: Nicholas K. Eib, San Jose, CA (US); Ebo H. Croffie, Portland, OR (US); Christopher Neville, Portland, OR (US); Neal P. Callan, Lake Oswego, OR (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 10/988,087

(22) Filed: Nov. 12, 2004

Related U.S. Application Data
(60) Provisional application No. 60/551,541, filed on Mar. 8, 2004.
(60) Provisional application No. 60/535,586, filed on Jan. 8, 2004.

(51) Int. Cl. G03B 27/42; G03B 27/54

(52) U.S. Cl. 355/67; 355/53

(57) ABSTRACT

The present invention provides methods and apparatus for accomplishing a phase shift lithography process using a blocker to block zero order light to improve image quality for phase shift lithography systems and methodologies. A maskless lithography system is provided. The lithography system provided uses a phase shift pattern generator which projects a phase shift image pattern along an optical path onto a photoimageable layer of a substrate in order to facilitate pattern transfer. A blocking element is interposed in the optical path to block zero order light in the image pattern, thereby improving image quality.

### CROSS-REFERENCE TO RELATED APPLICATIONS

This application claims priority of U.S. Provisional Patent Application No. 60/551,541, filed 8 Mar. 2004, entitled: “Apodization Applied to Maskless Optical Direct Write Lithography” which is incorporated herein by reference in its entirety for all purposes.

This application also claims priority of U.S. Provisional Patent Application No. 60/513,780 (Attorney Docket No. 03-1810), filed 22 Oct. 2003, which application is incorporated herein by reference in its entirety for all purposes.

This application also claims priority of U.S. Provisional Patent Application No. 60/535,586, filed 1 Jan. 2004, which application is incorporated herein by reference in its entirety for all purposes.

This application also claims priority of U.S. Utility patent application Ser. No. 10/825,342 (Attorney Docket No. 03-1810/LSI1P239), filed 14 Apr. 2004, which application is incorporated herein by reference in its entirety for all purposes.

### FIELD OF THE INVENTION

The present invention relates to methods and apparatus for forming patterns on substrate surfaces. More particularly, the present invention relates to methods for using apodization to improve the quality of phase shift patterns formed on a substrate to create semiconductor devices on the wafers.

### BACKGROUND

Designers and semiconductor device manufacturers constantly strive to develop smaller devices from wafers, recognizing that circuits with smaller features generally produce greater speeds and increased packing density, therefore increased net die per wafer (numbers of usable chips produced from a standard semiconductor wafer). To meet these requirements, semiconductor manufacturers have been forced to build new fabrication lines at the next generation process node (gate length). As the critical dimensions for these devices grow smaller, greater difficulties will be experienced in patterning these features using conventional photolithography.

Conventional photolithography methods used for pattern generation involve exposing a light sensitive photoresist layer to a light source. The light from the source is modulated using a reticle, typically a chrome on quartz mask. The patterns formed on the reticle are transferred to the photoresist layer using typically visible or ultraviolet light. The areas so exposed are then developed (for positive photoresist) or, alternatively, unexposed areas are developed for negative type photoresist. The developed regions are then washed away and the remaining photoresist pattern used to provide an etching mask for the substrate.

One approach to achieving the desired critical dimensions has been to use attenuated phase shift masks and strong phase shift masks. Although useful such masks suffer from a number of shortcomings. For one, phase shifting masks can be subject to aerial image intensity imbalances due to the presence of zero order light. This unbalancing can result in shifting of exposure patterns away from the desired exposure pattern. These complications have proven difficult to remedy.

Thus, the numerous present art lithography and chip fabrication processes suffer from focus aberrations and pattern drift induced by the presence of zero order light in the image pattern. In view of the above difficulties, what is needed is a relatively simple and effective solution to such processing difficulties.

### SUMMARY OF THE INVENTION

To achieve the foregoing, the present invention provides a lithography system configured to generate phase shift optical exposure patterns which are directed onto a substrate. System embodiments include a blocking element interposed between the target substrate and pattern generating optical elements to improve the quality of the image pattern projected onto the target substrate to facilitate an optical lithography process.

The present invention provides an improved lithography system that takes advantage of a blocking element introduced into an optical path to substantially reduce the negative effects of zero order light on phase shift optical image patterns used to facilitate pattern transfer onto a substrate.

A method embodiment of the invention involves providing a substrate having formed thereon a photosensitive layer. An image pattern is generated and directed along an optical path. A blocking element is interposed into the optical path to block a portion of light comprising the image pattern, thereby generating an apodized image pattern which is directed along the optical path onto the photosensitive layer to illuminate the photosensitive layer of the substrate thereby exposing the photosensitive layer to the apodized image pattern.

In another embodiment, the invention includes an optical lithography system. The system includes a phase shift mask reticle configured to generate a phase shift optical image pattern and an illumination source for directing electromagnetic waves onto the reticle to generate the image pattern which is projected along an optical path onto a substrate. The system includes a blocker element interposed into the optical path to block a portion of light forming the image pattern from reaching the substrate. The system has a stage configured to move the substrate to facilitate exposure of at least a portion of the substrate to the exposure pattern.

In another apparatus embodiment, the invention includes a maskless lithography system. The system includes a mirror array with a plurality of movable mirrors that can operate to generate a phase shift optical image pattern and control element capable of configuring the mirrors in a desired configuration. The system includes an illumination source for directing electromagnetic waves onto the mirror array to generate said image pattern that is projected along an optical path. The system includes a blocker element configured to block a portion of light forming the image pattern from reaching the substrate. The system has a stage configured to move the substrate to facilitate exposure of at least a portion of the substrate to the exposure pattern.

These and other features and advantages of the present invention are described below with reference to the drawings.

### BRIEF DESCRIPTION OF THE DRAWINGS

The following detailed description will be more readily understood in conjunction with the accompanying drawings, in which:

FIG. 1 is a schematic diagram illustrating an optical lithography system.

FIG. 2A is schematic diagram illustrating a diffraction pattern showing the zero order light.

FIG. 2B is schematic diagram illustrating the lack of phase interference in zero order light.

FIG. 2C is schematic diagram illustrating phase interference patterns generated by diffracted (non-zero order) light.

FIG. 3 is a schematic diagram illustrating one embodiment of the present invention and depicting the presence of zero-order light in an unfiltered lithography system.

FIG. 4 is a schematic diagram illustrating one embodiment of the present invention showing the effect of introducing a blocking element into the pupil plane to remove the zero-order light in accordance with one embodiment of the present invention.

FIG. 5 is a schematic plan view of a rotary mount embodiment illustrating various blocking elements that can be implemented in accordance with the principles of the present invention.

FIG. 6 is a schematic depiction of an embodiment of a maskless optical direct write lithography system constructed in accordance with the principles of the invention.

FIG. 7 is a flow diagram illustrating operations in performing apodized optical lithography processes to pattern a substrate in accordance with an embodiment of the present invention.

It is to be understood that in the drawings like reference numerals designate like structural elements. Also, it is understood that the depictions in the Figures are not necessarily to scale.

### DETAILED DESCRIPTION

The present invention has been particularly shown and described with respect to certain embodiments and specific features thereof. The embodiments set forth hereinbelow are to be taken as illustrative rather than limiting. It should be readily apparent to those of ordinary skill in the art that various changes and modifications in form and detail may be made without departing from the spirit and scope of the invention.

In the following detailed description, fabrication methods and apparatus for implementing optical lithography systems is set forth. Such systems can employ phase shift reticles to establish optical image patterns. Alternatively, so-called maskless optical direct write optical lithography systems can be used to generate the optical image patterns.

In accordance with one embodiment, a lithography system illuminates a phase shift reticle to generate a desired phase shift image pattern on a substrate. In such an embodiment a light source is directed onto a phase shift reticle to generate a diffraction that forms a desired set of (constructive and destructive) interference patterns which are selectively de-magnified and projected onto a substrate. Commonly, the substrate (e.g., a wafer or other substrate (for example, a reticle)) is covered with a layer of photoimageable material (for example, photoresist material) which is exposed using the image pattern. Subsequently, the photoimageable material is developed and selectively washed away to define a desired photoresist pattern which can then be used to transfer patterns onto the substrate. Such systems can include attenuated phase shift reticles and strong phase shift lithography systems. Such systems are commonly configured to generate strong phase shift optical exposure patterns which are projected as image patterns onto a target substrate (for example a wafer) to facilitate pattern transfer onto the substrate. Additionally, some embodiments of such systems can be configured to generate binary optical patterns that do not rely on phase shift effects to establish image patterns on a substrate.

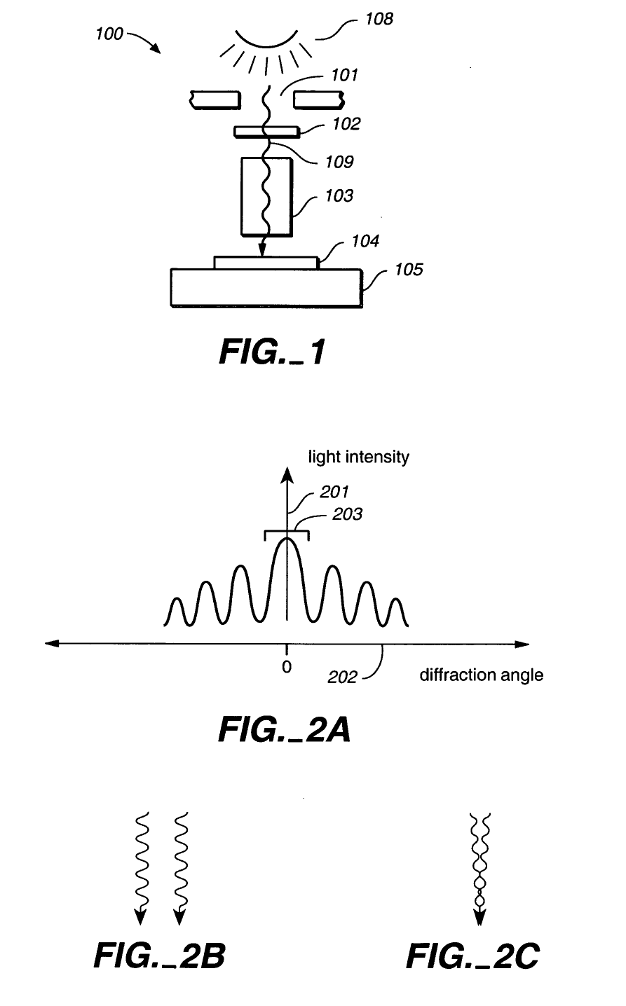

FIG. 1 is a schematic diagram a present art optical lithography system. The system 100 uses the optical mask 102 to modulate the light flux from the illumination source 108. The illumination source 108 generates light 109 which is passed through an aperture 101 onto a phase reticle 102 configured to create an optical phase pattern in the light as it passes through the reticle 102 where it is demagnified by focusing and demagnification optics 103. After passing through the focusing and demagnification optics 103 the optical phase pattern is directed onto the target substrate 104 which is mounted on a movable stage 105.

The phase shift mask 102 results in a light diffraction pattern that includes diffraction of differing intensities. FIG. 2A is a schematic graphical depiction of the relation between signal intensity 201 and diffraction angle (from the normal) 202 of the wavefronts diffracted by a phase mask. A zero order wavefront comprises the undiffracted light passing through the mask (or other optical element that functions as a grating). This zero order light 203 is shown at the central light intensity peak on or about zero degrees. This light is undiffracted and is parallel to the other undiffracted light. The presence of such zero order light is typically undesirable because it degrades the strong phase shift optical patterns desired. Strong phase shift patterns are achieved by the deliberate interference of two phase shifting regions that are intended to be 180 degrees out of phase. If the intensities of the two phase regions are equal in magnitude and roll off with distance, then the zero order light will be exactly canceled out. Non-cancellations can arise because the 180° region is etched, the 0° is not. These non-cancellations can arise because the 180° phase difference is not exactly 180°. Additionally, variations between etched and non-etched quartz caused deviations from a perfect interference profile. Also, the etched portions have “walls” which provide 3-D scattering effects. Additionally, slight differences bulk light absorbtion of the quartz cause unintended variation in the optical signal. This non-cancellation of zero order light is often referred to as “zero order leakage”. Current solutions require the addition 10 nm to the width of every 180° phase shift feature. Light having excessive amounts of non-cancellation cannot generate the phase interference patterns required for a phase shift mask to operate properly. FIG. 2B is a schematic diagram illustrating the lack of interference inherent in a pattern of parallel zero order light beams. Whereas, as depicted in schematic diagram FIG. 2C, diffracted light creates intersecting light beams of differing phase initiating interference pattern that result in the phase shift mask patterns known to those having ordinary skill in the art. As such, the presence of zero order light serves to distort the desired optical phase shift pattern in ways that are difficult to correct for.

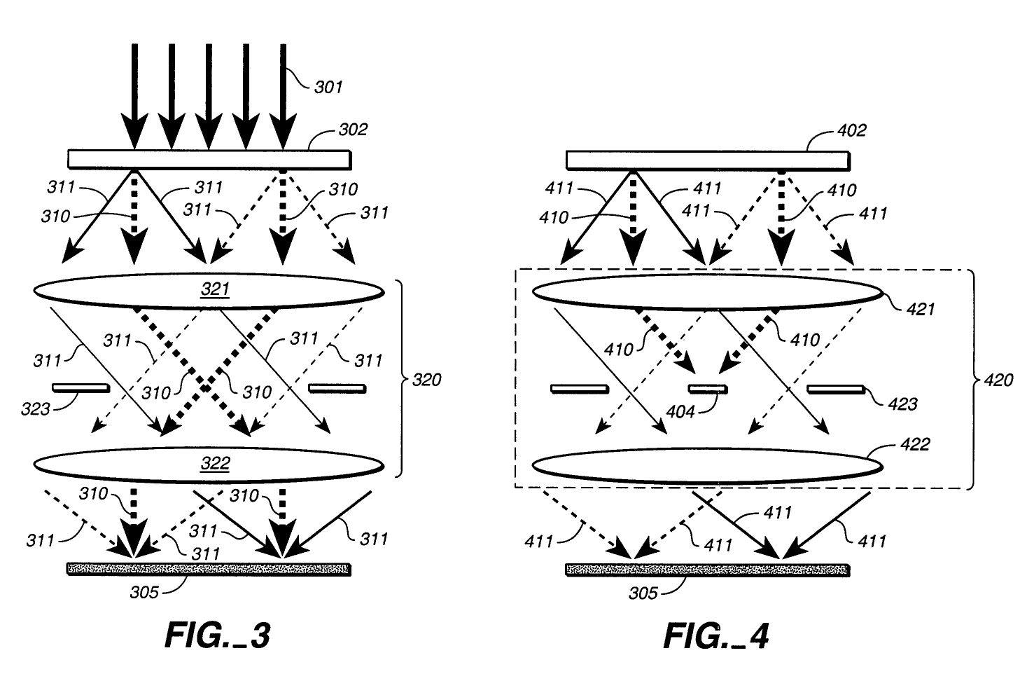

FIG. 3 is a figurative diagram that schematically illustrates this phenomenon. Illuminating light 301 is directed onto a phase mask 302 generating zero order light 310 and higher and lower order light 311 which is directed into a focusing and demagnification system 320. The depicted focusing and demagnification system 320 is schematically depicted having a first portion 321 and a second portion 322 and including a pupil plane 323. As is known to those having ordinary skill in the art such focusing and demagnification systems 320 are commonly much more complicated having many lenses. Moreover, the pupil plane 323 is frequently within one of the many lenses of the focusing and demagnification system 320. In any case, the zero order light 310 and other order light 311 is directed onto the target substrate 305 to form a degraded image.

FIG. 4 is a figurative diagram that schematically illustrates an embodiment of the present invention illustrating apodization in accordance with the principles of the invention. Illuminating light (not shown in this view) is directed onto a phase pattern generating element 402. Such elements 402 can be a phase shift mask or alternatively can be a mirror array of an optical direct write system (which will be discussed in greater detail herein). The phase pattern generating element 402 when illuminated generates zero order light 410 and higher and lower order light 411 which is directed onto a focusing and demagnification system 420. The depicted focusing and demagnification system 420 is schematically depicted having a first portion 421 and a second portion 422 and includes therein a pupil plane 423. As is known to those of ordinary skill in the art, many commonly used focusing and demagnification systems 420 employ very complicated optics constructed having many lenses. Moreover, such optical systems 420 commonly have a pupil plane 423. As is known, such pupil planes 423 can be within one of the many lenses of the focusing and demagnification system 420. Alternatively, in some implementations the pupil plane 423 can lie between lenses of a system 420. Again, the inventors specifically point out that these figures are schematic in nature and are for illustrative purposes and not intended to limit the invention. In any case, a blocking element 404 (or blocker) is employed to block the passage of the zero order light 410 while allowing the non-zero order light 411 to pass and be projected onto the target substrate 305 to form an image pattern (sometime referred to as an apodized image pattern). In one implementation, the blocker 404 is positioned in the pupil plane 423. Such apodization can be used to block zero order light to, for example, substantially reduce aerial image intensity imbalances and reduce the incidence of pattern drift.

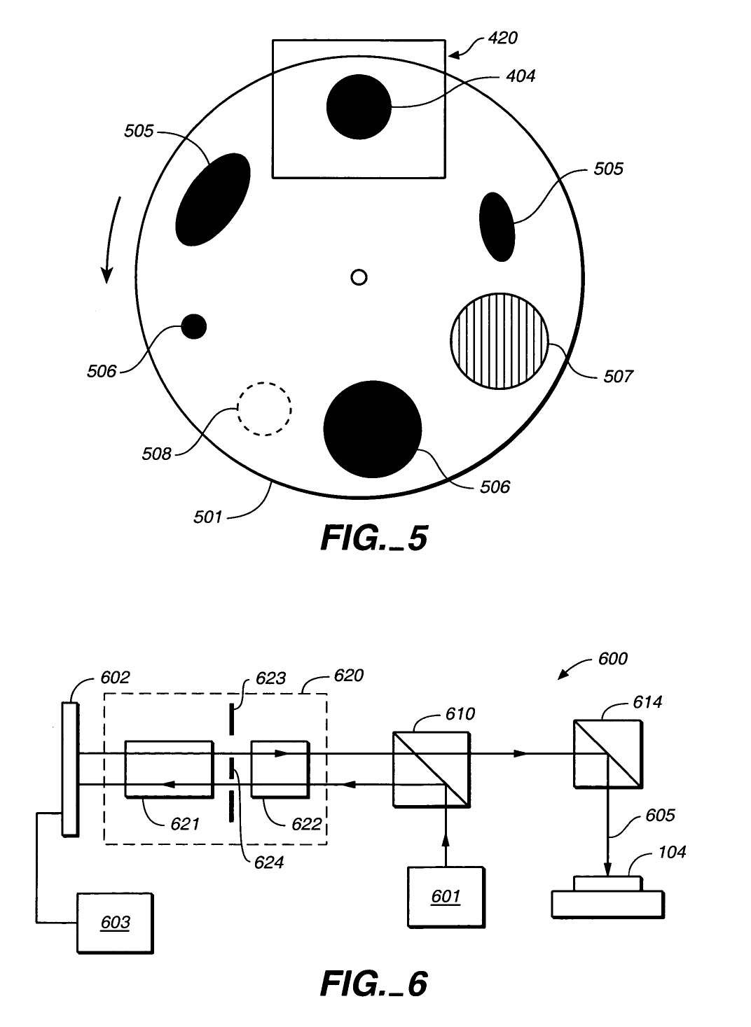

In another implementation different size blockers can be used to achieve differing degrees of apodization. FIG. 5 is a top down schematic view of one embodiment of the invention. The focusing and demagnification system 420 is schematically depicted with blocker 404 in an operative position. As stated, different size and shaped blockers can be used to achieve differing degrees of apodization. For example, elliptical blockers 505 of various sizes can be interposed for example, in the pupil plane, to achieve apodization. Also, larger and smaller blockers 506 can be employed to achieve apodization. For example, in some embodiments the blocker has a size that depends on the optical properties of the optical system in question. For example, the blocker can have the same diameter as the system σ where:

$$σ = \frac{sin ( \frac{{θ}_{max}}{2} )}{NA}$$

$$\frac{{θ}_{max}}{2}$$

being the maximum half angle for the optical system. NA refers to the numerical aperture of the optical system.

Alternatively, a diffraction grating 507 can be used as a blocker to selectively block certain wavelengths of light. Also, a polarizer could be used as a blocker. In one implementation, these various blockers (e.g., 404, 505, 506, & 507) could be mounted on a rotary mount 501 that can be rotated to interpose the desired blocker in the optical path of the light beam to achieve apodization. Additionally, in some embodiments, a setting with no blocker 508 can be used to allow the same system to operate in both binary and phase shift exposure modes. In implementations where the pupil plane lies within a lens, the rotary mount includes a series of substantially identical lens elements, each having a different blocker. By rotating the desired blocker into the correct position a specific configuration for the device can be implemented. As is known to those having, ordinary skill in the art, particular care must be taken to insure correct alignment and spacing of the rotatable lens elements. Another implementation of the invention concerns a direct write optical lithography system. Such systems are recently invented, for example being discussed in the previously referenced U.S. Utility patent application Ser. No. 10/825,342 (Attorney Docket No. 03-1810/LSI1P239), filed 14 Apr.

2004. Also, implementations of direct write optical lithography systems are taught in the concurrently filed U.S. Utility patent application (Attorney Docket No. LSI1 P245/04-0028), entitled “Process and Apparatus for Generating a Strong Phase Shift Optical Pattern for Use in an Optical Direct Write Lithography Process”, which application is incorporated herein by reference in its entirety for all purposes. In one example, the use of piston and tilted mirrors is described in “Optical Analysis of Mirror-Based Pattern Generation” by Y. Shroff, Yijian Chen, and W. G. Oldham; Proceedings of SPIE, Vol. 5037 (2003), the entire disclosure of which is incorporated herein by reference for all purposes. As a further example, integrated circuits comprising microelectronic mirror devices are available commercially. For example, Texas instruments, Inc. of Dallas, Tex. produces a Digital Micromirror Device (DMD) comprising an array of microscopically small square mirrors, each mirror corresponding to a pixel in the projected image. The individual micromirrors are hinged, allowing rotation on a diagonal axis, approximately +/−10 degrees from a neutral position.

Such systems use programmable optical mirrors in a maskless lithography system to form desired phase shift optical patterns on a substrate. Such maskless direct-write lithography systems use an array of mirrors configured to operate in phase shift or binary mode to generate a desired lithography pattern which is projected onto a substrate. The apparatus uses the mirror array to reflect light onto a photoimageable layer (for example, a photoresist layer) of a target substrate (e.g., a wafer or other substrate (for example, a reticle)) to achieve pattern transfer. Such systems can include optical direct write lithography systems. Such systems are commonly configured to generate strong phase shift optical exposure patterns which are projected as image patterns onto a target substrate (for example a wafer) to facilitate pattern transfer onto the substrate. Additionally, some embodiments of such systems can be configured to generate binary optical patterns that do not rely on phase shift effects to establish image patterns on a substrate.

FIG. 6 is a schematic diagram illustrating one possible implementation of an optical direct write system in accordance with one embodiment of the present invention. The system 600 uses the mirror array 602 to modulate the light flux from the illumination source 601. The illumination source 601 may be any illumination source capable of generating electromagnetic waves sufficient to reflect from the mirror array 602 and to induce chemical changes in a photosensitive layer on a substrate (e.g., wafer 104). In one embodiment, the illumination source 601 is an intermittent source, capable of exposing the wafer during selected periods of a continuous scan movement of the light beam relative to the wafer. Commonly (but not exclusively), the illumination source 601 is a coherent light source. In one embodiment, the illumination source 601 is an ArF excimer laser producing 193 nm (nanometer) output. Typically, the light from the source 601 is directed onto a mirror array 602 and projected onto the target substrate (here target wafer 104) using a beamsplitters 610, 614. As is known to those of ordinary skill many configurations and arrangements can facilitate projecting a desired light pattern onto a substrate in accordance with the principles of the invention.

The mirror array 602 can be reconfigured to generate many different patterns in accordance with the needs of the user. For example, each of the mirrors can be programmably actuated using, for example, a mirror array control element 603. Such a control element 603 can use software to actuate the individual mirrors of the array 602 to produce a desired optical pattern which is then projected onto a target substrate (here wafer 104) to produce a desired image. As alluded to above, the light from the illumination source 601 may be directed along an optical path 605 and onto the photosensitive wafer 104 by any suitable means as known to those of skill in the relevant art. In accordance with one embodiment, the mirror array 602 comprises a plurality of mirrors, each of the plurality of mirrors having a very small size. For example, mirrors having sides on the order of about 8 μm (micron) can be used. The inventors specifically point out that other sizes of mirrors can be used. The light from these mirrors can be demagnified using the focusing and demagnification optics 620 to generate image patterns having a final pixel size of about 30 nm on a side at the image plane (e.g., on the photosensitive layer of the wafer 104). Such demagnification can be accomplished using a number of lens elements which are schematically depicted here by elements 621 and 622. As previously indicated, these elements can schematically represent much more complicated lens structures. Generally, such elements can be configured much the same as the lens structures of FIGS. 3 & 4. Also, a pupil plane 623 is defined as part of the focusing and demagnification optics 620. As depicted here, the pupil plane 623 includes a blocker 624 interposed in the optical path 605 to substantially reduce the first order light signal impinging on the wafer 104. Although the apparatus illustrated is a catiotropic configuration, the scope of the invention is not so limited. That is, any configuration which allows the use of mirror arrays to direct light to a substrate is expected to be suitable and thus within the scope of the invention. As described previously, the inventors contemplate implementations where the blocker can be removed from the optical path to permit the formation of high quality binary image patterns which are directed onto the substrate for patterning. Also, as with previously described embodiments the apparatus can be configured to use blockers of different sizes and shapes to optimize the image pattern. Polarizers and other types of filters can be implemented as blockers as well.

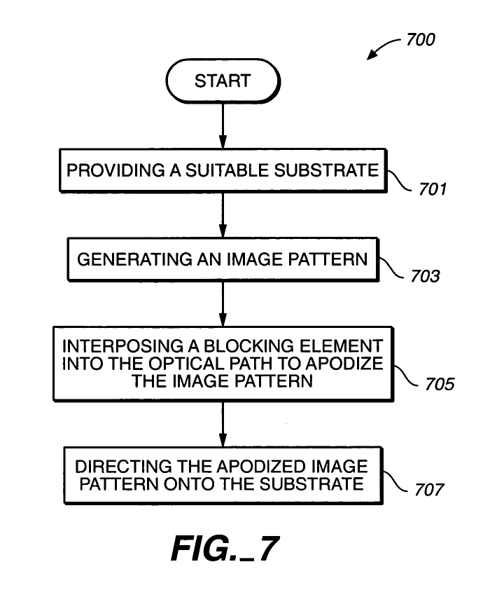

FIG. 7 is a flow diagram illustrating operations for performing optical lithography using apodization. In one method embodiment, a method of forming an image on a substrate implementing a blocker to facilitate apodization thereby improving the quality of a resultant image pattern is taught. The flow diagram 700 includes an operation of providing a substrate (Step 701). Typically, the substrate includes a layer of photosensitive material formed on the top surface. Such photosensitive materials comprise photoimageable materials such as photoresists and other related materials. An image pattern is then formed (Step 703). This image pattern is directed along an optical path which eventually allows the image pattern to be projected onto the substrate. In general, an optical beam is projected through an aperture onto a pattern generating element (e.g., a mask or properly configured mirror array) to form a desired image pattern. In one implementation, the image pattern is generated by a maskless optical direct write system. For example, such a system can be used to generate a phase shift image pattern which can be directed along an optical path to expose the photosensitive material of the substrate. In another implementation, the image pattern is generated by a maskless optical direct write system. Such a system can be used to generate a phase shift image patterns (or if desired binary patterns) which can be directed along an optical path to expose the photosensitive material of the substrate. A blocking element is interposed into the optical path to block a portion of light comprising the image pattern thereby generating an apodized image pattern (Step 705). As discussed, such apodized image patterns are filtered by the blocking element to remove substantially all first order signal from the image pattern. In one implementation a circular blocking element about the same size as the aperture is interposed into the optical path to form the apodized image pattern. Embodiments of the invention can use blocking elements having different sizes and shapes. Also, embodiments of the invention can be position the blocking element in the pupil plane of a focusing and demagnification system. After filtering with the blocking element the apodized image pattern is directed onto the photosensitive layer of the substrate to facilitate pattern transfer (Step 707). This apodized image pattern can be projected onto a wafer surface using, for example, a raster scan process that steps over the entire wafer surface. Many other lithography techniques known to those having ordinary skill in the art can be implemented to accomplish pattern transfer in accordance with the principles of the invention.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method of forming a pattern on a substrate, the method comprising:
providing a substrate having formed thereon a photosensitive layer;
providing a mirror array configured to generate a phase shift image pattern;
illuminating the mirror array to generate a phase image pattern that is directed along an optical path;
interposing a blocking element into the optical path to block a portion of light comprising the image pattern thereby generating an apodized image pattern; and
directing the apodized image pattern onto the photosensitive layer to facilitate transfer of the apodized image pattern onto the photosensitive layer.

2. The method of claim 1 wherein the image pattern includes a portion comprising a zero diffraction order signal comprising substantially undiffracted light and a portion having higher diffraction order signals comprising diffracted light; and
wherein interposing a blocking element into the optical path comprises interposing the blocking element to block the zero diffraction order signal.

3. The method of claim 2 wherein the optical path includes a pupil plane and wherein interposing a blocking element comprises interposing the blocker at the pupil plane to block the zero diffraction order signal thereby generating an apodized image pattern.

4. The method of claim 1 wherein interposing a blocking element into the optical path comprises interposing one of several available size blocking elements.

5. The method of claim 4 wherein interposing one of several available size blocking elements includes rotatably interposing one of the several available size blocking elements into the optical path.

6. The method of claim 4 wherein illuminating the mirror array comprises projecting light from the light source onto the mirror array through an aperture having a known σ; and
wherein interposing the blocking element comprises interposing a blocking element having a diameter of σ.

7. The method of claim 1 wherein the optical path includes a pupil plane and wherein interposing a blocking element comprises interposing the blocker at the pupil plane to block a portion of light thereby generating an apodized image pattern.

8. The method of claim 1 wherein providing a mirror array configured to generate a phase shift image pattern includes providing a programmable mirror array that can be reconfigured to generate more than one phase shift optical image pattern.

9. A maskless lithography system comprising:
a mirror array comprising a plurality of movable mirrors arranged to produce phase shift optical image patterns;
a control element capable of reconfiguring the plurality of movable mirrors into different arrangements enabling the generation of phase shift optical image patterns;
an illumination source for directing electromagnetic waves along an optical path onto the mirror array to thereby generating a phase shift optical image pattern that is projected along said optical path onto a substrate; and
a blocker element positioned to block a portion of light forming the phase shift optical image pattern from reaching the substrate.

10. The system of claim 9 further including a stage configured to move the substrate to facilitate exposure of at least a portion of the substrate to the phase shift optical image pattern.

11. The system of claim 9 wherein the phase shift optical image pattern includes a diffraction pattern having a zero diffraction order signal comprising undiffracted light and higher diffraction order signals comprising diffracted light; and
wherein the blocking element is configured to block the zero diffraction order signal when interposed in the optical path.

12. The system of claim 11 wherein the diameter of the blocker is configured to have the same diameter as an aperture of the illumination source.

13. The system of claim 11 wherein the optical path includes along its length a pupil plane; and
wherein the blocking element is interposed in the pupil plane.

14. The system of claim 11 wherein the optical path includes along its length an optical lens structure for focusing and magnifying the electromagnetic waves produced by illumination source, said optical lens structure having a pupil plane; and
wherein the blocking element is configured to block the zero diffraction order signal when interposed in the pupil plane.

15. The system of claim 13 wherein optical lens structure includes a rotary lens element in the pupil plane enabling blockers of various sizes to be interposed at the pupil plane.

16. The system of claim 14 wherein optical lens structure includes a rotary lens element in the pupil plane enabling blockers of various sizes to be interposed at the pupil plane.

17. The system of claim 15 wherein the mirror array is reconfigurable by the control element so that the plurality of movable mirrors operate to generate a binary optical image pattern; and
wherein the rotary lens element is configured to remove the blocker from the optical path when the mirror array is configured to generate a binary optical image pattern.
